(19) United States
(12) Patent Application Publication
(10) Pub. No.: US 2017/0369012 A1
(43) Pub. Date: Dec. 28, 2017

(54) GROUNDING OF A SHAFT

(71) Applicants: ZF Friedrichshafen AG, Friedrichshafen (DE); ZF WIND POWER ANTWERPEN N.V., Lommel (BE)

(72) Inventors: Georg TENCKHOFF, Friedrichshafen (DE); Kurt ENGELEN, Mol (BE); Alejandro MARTIN BARRIOS, Lommel (BE)

(21) Appl. No.: 15/632,442

(22) Filed: Jun. 26, 2017

(30) Foreign Application Priority Data
Jun. 28, 2016 (DE) 10 2016 211 616.9

(51) Int. Cl. B60R 16/06; H05F 3/04

(52) U.S. Cl. CPC B60R 16/06; H05F 3/04

(57) ABSTRACT

A transmission having a first component (101) mounted so as to rotate, a rotationally fixed second component (105) and a third component (107). The first component has a radially extending face and the third component (107) is fixed in the second component (105). The third component (107) is braced against the face and the third component (107) electrically connects the face and the second component (105) to one another.

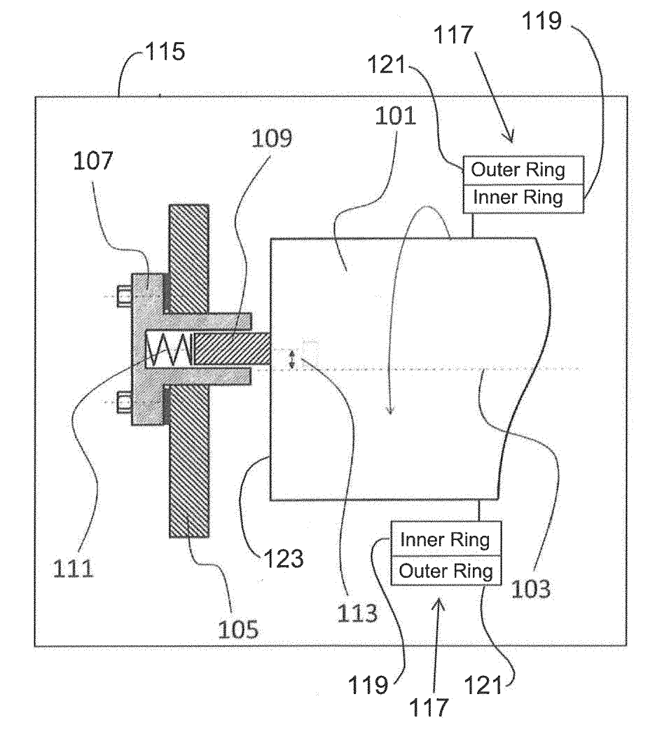

This application claims priority from German patent application serial no. 10 2016 211 616.9 filed Jun. 28, 2016.

### FIELD OF THE INVENTION

The invention concerns a transmission.

### BACKGROUND OF THE INVENTION

Electric currents can give rise to decarburiza ion and sparking in bearings. The result is damage to the bearing, which can ultimately lead to failure.

To avoid the flow of current in a bearing, various solutions are known from the prior art which are designed to achieve potential equalization. These include carbon brushes, shaft grounding rings and telescopic brushes. Such means are suitable for avoiding currents in the range of a few milliamperes to several amperes.

However, more recent research has yielded the knowledge that even very small currents, i.e. currents in the microampere range, can cause damage to bearings. Such currents seem to be responsible for the production of so-termed White Etching Cracks (WEC).

The means described earlier are not suitable for avoiding currents in the microampere range when used in an oily environment. The oil produces an insulating film which prevents complete potential equalization. This problem becomes more acute, the faster the bearing to be grounded is rotating.

### SUMMARY OF THE INVENTION

The purpose of the present invention is to overcome the inadequacies and disadvantages inherent in the solutions known from the prior art. In particular, damage to bearings due to White Etching Cracks should be avoided.

This objective is achieved by a transmission according the claims.

The transmission comprises a first component mounted so that it can rotate, a rotationally fixed second component and a third component. In particular, the first component can rotate relative to the second component. Preferably, the first component is also mounted to rotate in the second component. Thus, for example, the second component is a housing of the transmission.

The first component has a face that extends radially. This is a surface directed perpendicularly to a rotational axis of the first component. Preferably, the radially extending face is flat. The face is part of the surface of the first component. In particular, it can be a partial surface of a larger area.

The third component is fixed in the second component. Preferably, this is done by means of a solid connection which does not allow any translational or rotational degrees of freedom. In the case of a solid connection, at least part of the third component is attached in a fixed position relative to the second component.

According to the invention, the third component is braced against the face in such manner that by virtue of the third component an electrically conducting connection is formed between the face and the second component. Since the face is a face of the first component, there is therefore also an electrically conducting connection between the first component and the second component.

By virtue of the electrically conducting connection between the first component and the second component, potential equalization takes place. Since the face against which the third component is braced extends radially, the third component can be arranged close to the rotational axis of the first component. This reduces the relative speed with which the face slides on the third component. In turn, this prevents the formation of an insulating oil film between the face and the first component, which would oppose potential equalization due to increased Ohmic resistance.

In a preferred further development, the first component is electrically connected to at least part of a bearing, such as a roller bearing. In particular, by virtue of the bearing the first component can rotate—for example in the second component. This entails fixing the first component in an inner ring and an outer ring of the bearing. That fixing is electrically conducting. As a result of the potential equalization between the first component and the second component, there is also potential equalization relative to the bearing.

In an also preferred further development, the face is rotationally symmetrical relative to the rotational axis of the first component. Because of this, during rotation of the first component, the third component slides over the face.

The first component is preferably developed further as a shaft. Alternatively, the first component is an axle. According to this further development the face is an end-face of the shaft.

The end-face of a shaft is defined as a face that delimits the shaft in the axial direction. The shaft has two end-faces. An end-face of a shaft can be defined as the locus of all points on the surface of the shaft which can be projected by axial projection, i.e. parallel projection in the axial direction, onto a flat surface that extends radially, i.e. perpendicularly to the rotational axis of the shaft.

The third component is preferably developed further with an electric contact. That contact is braced against the radially extending face of the first component.

Preferably, the third component is also further developed by incorporating a spring. The spring is stressed against the contact so that a spring force acts on the contact. This results in the above-mentioned bracing of the contact against the face.

The contact can perhaps be in the form of a ball. In particular, as the third component a commercially available ball plunger can be used.

In an also preferred further development, the contact consists at least in part of hardened steel. Hardened steel can be produced by transformation hardening, precipitation hardening or cold-work hardening. The use of hardened steel is first enabled by the bracing of the contact against a radially extending surface. Compared with the solutions known from the prior art, this makes for improved wear behavior.

Relative to the first component, the third component can be positioned concentrically or eccentrically. In a concentric arrangement a central axis of the third component, preferably an axis of symmetry relative to which the third component is rotationally symmetrical, coincides with the rotational axis of the first component. In this case the face of the first component against which the third component is braced is preferably of circular shape. In particular, the surface can be punctiform. A concentric arrangement of the third component has the advantage that the wear that occurs due to friction between the third component and the surface is minimized.

In an eccentric arrangement of the third component, a central axis of the third component, preferably the symmetry axis relative to which the third component is rotationally symmetrical, extends a distance away from the rotational axis of the first component, the distance being different from zero. In this case the face of the first component against which the third component is braced is preferably shaped as a circular ring. The eccentric arrangement of the third component avoids the possibility that as a result of corrosion, the transfer resistance between the first and third components will increase.

### BRIEF DESCRIPTION OF THE DRAWINGS

A preferred example embodiment of the invention is shown in the sole FIGURE, in which matching indexes denote similar or functionally equivalent features. In detail, the sole FIGURE shows an earthed shaft.

### DETAILED DESCRIPTION OF THE PREFERRED EMBODIMENTS

The shaft 101 of a transmission 115 has two end-faces with only one end-face 123 being shown in the FIGURE. The shaft 101 is mounted so that it can rotate about a rotational axis 103. The shaft 101 shown in the FIGURE is electrically connected to at least part of a bearing 117, such as a roller bearing. In particular, by virtue of the bearing 117, the shaft 101 can rotate—for example in the housing 105. This entails fixing the shaft 101 in an inner ring 119 and an outer ring 121 of the bearing 117. Also shown in the FIGURE is a transmission housing 105. To the transmission housing 105 are attached means 107 for grounding the shaft 101. The means 107 are electrically connected to the transmission housing 105. Furthermore, the means 107 comprise an electrically conductive pin 109. This is loaded by a spring 111 and pressed against the shaft 101, so that an electrically conductive connection is formed between the shaft 101 and the transmission housing 105.

The means 107 with the pin 109 and the spring 111 are arranged offset relative to the rotational axis 103 by a radial distance 113. This results in a self-cleaning effect of the electrically conductive connection between the pin 109 and the shaft 101.

Compared with the radius of the shaft 101, the distance 113 is small. For example, the distance 113 can be less than 20%, less than 15%, less than 10% or even less than 5% of the radius of the shaft 101.

### INDEXES

101 Shaft
103 Rotational axis
105 Transmission housing
107 Means for grounding the shaft
109 Pin
111 Spring
113 Radial distance

1-11. (canceled)

12. A transmission comprising:
a first component (101) mounted so as to rotate;
a rotationally fixed second component (105);
a third component (107);
the first component (101) having a radially extending face;
the third component (107) being fixed in the second component (105);
the third component (107) being braced against the face of the first component (101); and
the third component (107) electrically connecting the face of the first component (101) and the second component (105) to one another.

13. The transmission according to claim 12, wherein the first component (101) is electrically connected to at least part of a bearing.

14. The transmission according to claim 12, wherein the face is rotationally symmetrical relative to a rotational axis (103) of the first component (101).

15. The transmission according to claim 12, wherein the first component (101) is a shaft and the face is part of an end-face of the shaft.

16. The transmission according to claim 12, wherein the third component (107) comprises an electrical contact (109) and the contact (109) is braced against the face.

17. The transmission according to the claim 16, wherein the third component (107) comprises a spring (111), and the spring (111) is braced against the contact (109).

18. The transmission according to claim 16, wherein the contact (109) comprises at least in part hardened steel.

19. The transmission according to claim 12, wherein the third component (107) is arranged concentrically with respect to the first component (101).

20. The transmission according to claim 19, wherein the face has a circular shape.

21. The transmission according to claim 12, wherein the third component (107) is arranged eccentrically relative to the first component (101).

22. The transmission according to claim 21, wherein the face has a shape of a circular ring.

23. A transmission comprising:
a housing;
a shaft and the shaft being mounted within the housing by a bearing such that the shaft being rotatable about a rotational axis with respect to the housing;
the shaft being electrically connected to the bearing and having an end face that extends radially;
a connecting component being connected to the housing such that at least a portion of the connecting component is fixed in position relative to the housing; and
the connecting component being braced against the end face of the shaft such that the connecting component electrically connects the end face of the shaft to the housing to equalize electrical potential between the bearing, the shaft and the housing.

24. The transmission according to claim 23, wherein the connecting component comprises an electrical contact and a spring, the spring abuts against the electrical contact and pushes the electrical contact such that the electrical contact abuts the end face of the shaft.

25. The transmission according to claim 24, wherein the connecting component is connected to the housing such that the electrical contact is offset laterally from the rotational axis.

26. The transmission according to claim 25, wherein the end face of the shaft is rotationally symmetrical relative to the rotational axis of the shaft such that the electrical contact slides over the end face of the shaft as the shaft rotates.

27. The transmission according to claim 24, wherein the connecting component is cylindrical and has a closed end and an axially opposite open end, the closed end of the connecting component is immovably fixed to the housing and the open end of the connecting component faces the end face of the shaft, the spring and the electrical contact are received within an interior of the connecting component such that the spring abuts the electrical contact and the closed end of the shaft, and the spring applies a biasing force on the electrical contact such that the electrical contact extends through the open end of the connecting component and abuts against the end face of the shaft.

28. The transmission according to claim 27, wherein an end surface of the electrical contact that abuts against the end face of the shaft is offset laterally from the rotational axis.
